(19) United States
(12) Patent Application Publication
(10) Pub. No.: US 2026/0002006 A1
(43) Pub. Date: Jan. 1, 2026

(54) Thermoplastic Foam Composition Including Biomass-Based Carbonaceous Particulate Material

(71) Applicant: Proprietect L.P., Toronto (CA)

(72) Inventors: Alireza Tabatabaei Naeini, Toronto (CA); Abbas Ghanbari, Winnipeg (CA); Blerina Vata, Woodbridge (CA)

(73) Assignee: Proprietect L.P., Toronto, ON (CA)

(21) Appl. No.: 18/996,726

(22) PCT Filed: Jul. 19, 2023
(86) PCT No.: PCT/IB2023/057375

§ 371 Date: Jan. 17, 2025

Related U.S. Application Data
(60) Provisional application No. 63/390,792, filed on Jul. 20, 2022.

(51) Int. Cl. C08J 9/00; C08K 3/04

(52) U.S. Cl. CPC C08J 9/0066; C08K 3/04; C08J 2323/14; C08J 2375/04; C08K 2201/005; C08K 2201/006

(57) ABSTRACT

A thermoplastic foam composition for low-density and high-stiffness articles includes a thermoplastic foam and an unactivated biomass-based carbonaceous particulate material encapsulated in the thermoplastic foam. The thermoplastic foam composition has a core density of between 12 grams per liter and 400 grams per liter as measured pursuant to ASTM-D3575-W Test Method A. The thermoplastic foam composition also has an elastic modulus of between 60 pounds per square inch and 3500 pounds per square inch as measured pursuant to ASTM-C203 Method I, Equation 13.

### BACKGROUND OF THE INVENTION

### 1. Field of the Invention

The present invention generally relates to a thermoplastic foam composition including a biomass-based carbonaceous particulate material.

### 2. Description of the Related Art

Foam compositions commonly include a polymeric foam and additives encapsulated in the polymeric foam. One additive that is commonly encapsulated in polymeric foams is carbon black. Carbon black is a colorant that provides color to the polymeric foam and is an ultraviolet (UV) stabilizer that protects the polymeric foam from degradation resulting from exposure to ultraviolet energy. However, carbon black is a petroleum-based additive produced from the reaction of hydrocarbon fuel with air at high temperatures and thus is non-renewable and not sustainable, has a high global warming potential (GWP), and leaves a large carbon footprint.

As such, there remains a need to provide improved foam compositions.

### SUMMARY OF THE INVENTION AND ADVANTAGES

The present invention provides a thermoplastic foam composition for low-density and high-stiffness articles. The thermoplastic foam composition includes a thermoplastic foam and an unactivated biomass-based carbonaceous particulate material encapsulated in the thermoplastic foam. The thermoplastic foam composition has a core density of between 12 grams per liter and 400 grams per liter as measured pursuant to ASTM-D3575-W Test Method A. The thermoplastic foam composition also has an elastic modulus of between 60 pounds per square inch and 3500 pounds per square inch as measured pursuant to ASTM-C203 Method I, Equation 13.

The present invention also provides a thermoplastic polyurethane foam composition for low-density and high-stiffness articles. The thermoplastic polyurethane foam composition includes a thermoplastic polyurethane foam and a biomass-based carbonaceous particulate material encapsulated in the thermoplastic polyurethane foam. The thermoplastic polyurethane foam composition has a core density of between 12 grams per liter and 400 grams per liter as measured pursuant to ASTM-D3575-W Test Method A. The thermoplastic polyurethane foam composition also has an elastic modulus of between 60 pounds per square inch and 700 pounds per square inch as measured pursuant to ASTM-C203 Method I, Equation 13.

The unactivated biomass-based carbonaceous particulate material and the biomass-based carbonaceous particulate material are a non-petroleum-based additives, are a renewable resource and are sustainable, have a low global warming potential (GWP), and leave a low carbon footprint. More specifically, the unactivated biomass-based carbonaceous particulate material and the biomass-based carbonaceous particulate material have a low carbon footprint because the biomass from which the unactivated biomass-based carbonaceous particulate material and from which the biomass-based carbonaceous particulate material is derived has sequestered carbon dioxide from the atmosphere during its life. Moreover, the unactivated biomass-based carbonaceous particulate material and the biomass-based carbonaceous particulate material are suitable for encapsulation in foam to provide a low-density article, while also modulating the elastic modulus of the foam to provide a high-stiffness article.

There has thus been outlined certain features of embodiments of the invention in order that the detailed descriptions thereof may be better understood, and in order that the present contribution over the art may be better appreciated. Additional or alternative features of embodiments of the invention are described in further detail below.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a scanning electron microscope image of a thermoplastic foam composition including a thermoplastic foam and a biomass-based carbonaceous particulate material encapsulated in the thermoplastic foam;

FIG. 2 is a scanning electron microscope image of the thermoplastic foam composition of FIG. 1 at a higher resolution; and

FIG. 3 is a scanning electron microscope image of the thermoplastic foam composition of FIGS. 1 and 2 at a higher resolution.

### DETAILED DESCRIPTION OF THE INVENTION

With reference to the Figures, a thermoplastic foam composition for low-density and high-stiffness articles is provided. The thermoplastic foam composition includes a thermoplastic foam and an unactivated biomass-based carbonaceous particulate material encapsulated in the thermoplastic foam. The thermoplastic foam composition has a core density of between 12 grams per liter and 400 grams per liter as measured pursuant to ASTM-D3575-W Test Method A. The thermoplastic foam composition also has an elastic modulus of between 60 pounds per square inch and 3500 pounds per square inch as measured pursuant to ASTM-C203 Method I, Equation 13.

The unactivated biomass-based carbonaceous particulate material is a non-petroleum-based additive, is a renewable resource and is sustainable, has a low global warming potential (GWP), and leaves a low carbon footprint. More specifically, the unactivated biomass-based carbonaceous particulate material has a low carbon footprint because the biomass from which the unactivated biomass-based carbonaceous particular material is derived has sequestered carbon dioxide from the atmosphere during its life. Moreover, the unactivated biomass-based carbonaceous particulate material is suitable for encapsulation in the thermoplastic foam to provide a low-density article, while also modulating the elastic modulus of the thermoplastic foam to provide a high-stiffness article. The unactivated biomass-based carbonaceous particulate material may be a colorant that provides color to the thermoplastic foam and may be an ultraviolet (UV) stabilizer that protects the thermoplastic foam from degradation resulting from exposure to ultraviolet energy.

The unactivated biomass-based carbonaceous particulate material is derived from a biomass feedstock that has been subjected to pyrolysis including, but not limited to, tree material (e.g. wood, wood chips, and/or leaves) from coniferous and/or deciduous trees, including acer trees, more specifically acer psuedoplatanus trees including both wood, wood chips, and/or leaves therefrom, which are some of the most common maple foliage's in Europe, nut shells (e.g. coconut shells, walnut shells, hazelnut shells, peanut shells, etc.), bamboo, rice hulls, grasses, corn stover, plant matter, seeds, paper, cardboard, manure, other agricultural residues, biorefinery residues, sorghum, dried algae, coffee beans, coffee grounds, grounds, sugar cane bagasse, and any combination thereof, among other possibilities.

The unactivated biomass-based carbonaceous particulate material is untreated beyond being derived from a biomass feedstock that has been subject to pyrolysis. In other words, the unactivated biomass-based carbonaceous particulate material is not be treated with steam or chemical treatment(s) which would activate the unactivated biomass-based carbonaceous particulate material, and which increase the porosity of the unactivated biomass-based carbonaceous particulate material, increase the specific surface area of the unactivated biomass-based carbonaceous particulate material, and decrease the relative ash content of the unactivated biomass-based carbonaceous particulate material. The steam or chemical treatment(s) necessary to activate the unactivated biomass-based carbonaceous particulate material increase the net carbon dioxide emissions, increase the carbon footprint, and increases the global warming potential of the thermoplastic foam composition. Utilizing unactivated biomass-based carbonaceous particulate material reduces carbon dioxide emissions by approximately 2.5 pounds of carbon dioxide per pound of unactivated biomass-based carbonaceous particulate material as compared to activated biomass-based carbonaceous particulate material.

The unactivated biomass-based carbonaceous particulate material is porous. The porosity of the unactivated biomass-based carbonaceous particulate material may be greater than 50%, greater than 55%, greater than 60%, greater than 65%, greater than 70%, greater than 75%, greater than 80%, greater than 85%, greater than 90%, or greater than 95%. The porosity of the unactivated biomass-based carbonaceous particulate material may be between 50% and 90%, between 60% and 80%, between 65% and 75%, or about 70%. It is to be appreciated that the porosity of the unactivated biomass-based carbonaceous particulate material varies dependent upon the particular biomass from which the unactivated biomass-based carbonaceous particulate material is derived.

The unactivated biomass-based carbonaceous particulate material may have a specific surface area of between 150 square meters per gram of the unactivated biomass-based carbonaceous particulate material and 495 square meters per gram of the unactivated biomass-based carbonaceous particulate material. The unactivated biomass-based carbonaceous particulate material may have a specific surface area of between 190 square meters per gram of the unactivated biomass-based carbonaceous particulate material and 495 square meters per gram of the unactivated biomass-based carbonaceous particulate material, between 200 square meters per gram of the unactivated biomass-based carbonaceous particulate material and 485 square meters per gram of the unactivated biomass-based carbonaceous particulate material, between 250 square meters per gram of the unactivated biomass-based carbonaceous particulate material and 485 square meters per gram of the unactivated biomass-based carbonaceous particulate material, between 300 square meters per gram of the unactivated biomass-based carbonaceous particulate material and 485 square meters per gram of the unactivated biomass-based carbonaceous particulate material, between 200 square meters per gram of the unactivated biomass-based carbonaceous particulate material and 450 square meters per gram of the unactivated biomass-based carbonaceous particulate material, between 200 square meters per gram of the unactivated biomass-based carbonaceous particulate material and 400 square meters per gram of the unactivated biomass-based carbonaceous particulate material, between 200 square meters per gram of the unactivated biomass-based carbonaceous particulate material and 350 square meters per gram of the unactivated biomass-based carbonaceous particulate material, or between 200 square meters per gram of the unactivated biomass-based carbonaceous particulate material and 300 square meters per gram of the unactivated biomass-based carbonaceous particulate material.

The unactivated biomass-based carbonaceous particulate material may be between 0.1 percent by weight and 25 percent by weight of the thermoplastic foam composition. Moreover, the unactivated biomass-based carbonaceous particulate material may be between 0.5 percent by weight and 20 percent by weight of the thermoplastic foam composition, between 0.5 percent by weight and 15 percent by weight of the thermoplastic foam composition, between 0.5 percent by weight and 12 percent by weight of the thermoplastic foam composition, between 0.5 percent by weight and 10 percent by weight of the thermoplastic foam composition, between 0.5 percent by weight and 8 percent by weight of the thermoplastic foam composition, between 0.5 percent by weight and 6 percent by weight of the thermoplastic foam composition, between 0.5 percent by weight and 5 percent by weight of the thermoplastic foam composition, between 0.5 percent by weight and 4 percent by weight of the thermoplastic foam composition, between 0.5 percent by weight and 3 percent by weight of the thermoplastic foam composition, between 0.5 percent by weight and 2 percent by weight of the thermoplastic foam composition, or between 0.5 percent by weight and 1 percent by weight of the thermoplastic foam composition. Additionally, the unactivated biomass-based carbonaceous particulate material may be between 1 percent by weight and 20 percent by weight of the thermoplastic foam composition, between 1 percent by weight and 15 percent by weight of the thermoplastic foam composition, between 1 percent by weight and 12 percent by weight of the thermoplastic foam composition, between 1 percent by weight and 10 percent by weight of the thermoplastic foam composition, between 1 percent by weight and 8 percent by weight of the thermoplastic foam composition, between 1 percent by weight and 6 percent by weight of the thermoplastic foam composition, between 1 percent by weight and 5 percent by weight of the thermoplastic foam composition between 1 percent by weight and 4 percent by weight of the thermoplastic foam composition, between 1 percent by weight and 3 percent by weight of the thermoplastic foam composition, and between 1 percent by weight and 2 percent by weight of the thermoplastic foam composition.

Furthermore, the unactivated biomass-based carbonaceous particulate material may be between 2 percent by weight and 20 percent by weight of the thermoplastic foam composition, between 2 percent by weight and 15 percent by weight of the thermoplastic foam composition, between 2 percent by weight and 12 percent by weight of the thermoplastic foam composition, between 2 percent by weight and 10 percent by weight of the thermoplastic foam composition, between 2 percent by weight and 8 percent by weight of the thermoplastic foam composition, between 2 percent by weight and 6 percent by weight of the thermoplastic foam composition, between 2 percent by weight and 5 percent by weight of the thermoplastic foam composition, between 2 percent by weight and 4 percent by weight of the thermoplastic foam composition, and between 2 percent by weight and 3 percent by weight of the thermoplastic foam composition. Further still, the unactivated biomass-based carbonaceous particulate material may be between 3 percent by weight and 20 percent by weight of the thermoplastic foam composition, between 3 percent by weight and 15 percent by weight of the thermoplastic foam composition, between 3 percent by weight and 12 percent by weight of the thermoplastic foam composition, between 3 percent by weight and 10 percent by weight of the thermoplastic foam composition, between 3 percent by weight and 8 percent by weight of the thermoplastic foam composition, between 3 percent by weight and 6 percent by weight of the thermoplastic foam composition, between 3 percent by weight and 5 percent by weight of the thermoplastic foam composition, and between 3 percent by weight and 4 percent by weight of the thermoplastic foam composition.

It is to be appreciated that the unactivated biomass-based carbonaceous particulate material may even be more than 20 percent by weight of the thermoplastic foam composition. Although not required, the thermoplastic foam is typically petroleum-based. It is to be appreciated that the unactivated biomass-based carbonaceous particulate material supplants the thermoplastic foam with respect to the relative weight percentages in the thermoplastic foam composition. As such, higher weight percentages of the unactivated biomass-based carbonaceous particulate material in the thermoplastic foam composition reduce the relative weight percentage of the thermoplastic foam in the thermoplastic foam composition, thus further lowering the carbon footprint of the thermoplastic foam composition.

Higher weight percentages of the unactivated biomass-based carbonaceous particulate material in the thermoplastic foam composition do not increase the melt pressure and, if processed with an extruder, do not increase the extruder torque. As such, the encapsulation of the unactivated biomass-based carbonaceous particulate material in the thermoplastic foam composition does not increase the energy consumption during extrusion. The encapsulation of the unactivated biomass-based carbonaceous particulate material in the thermoplastic foam also had little to no significant effect on the viscosity or the rheological behavior of the thermoplastic foam.

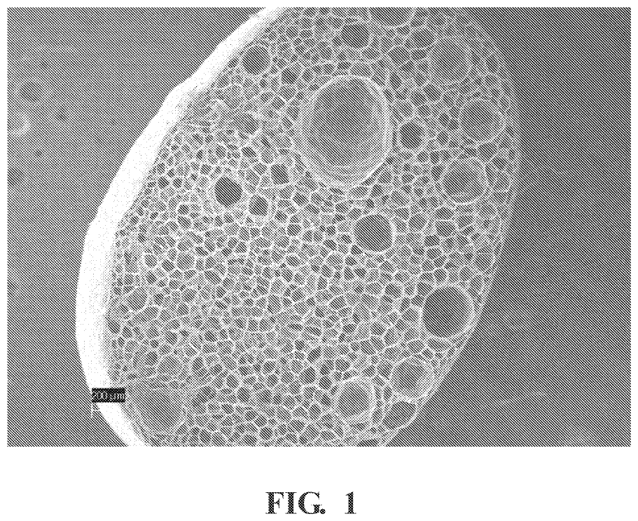

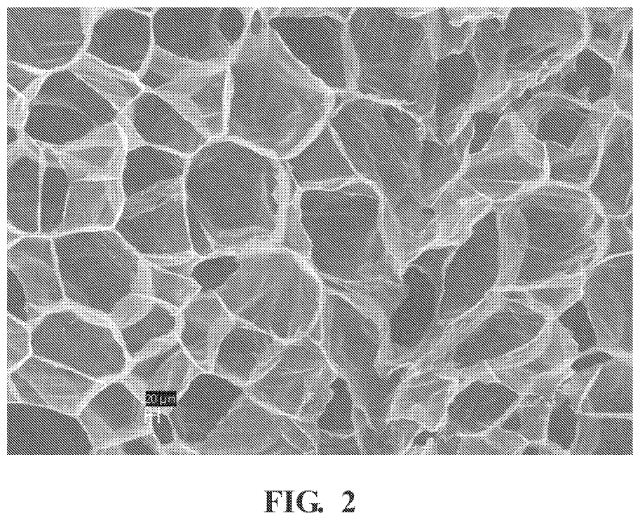

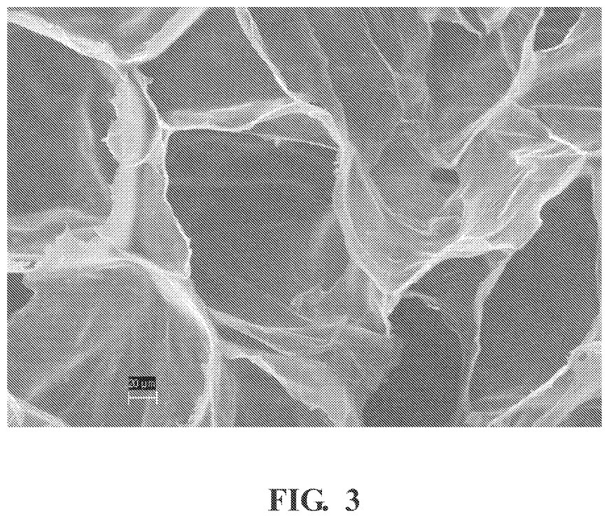

As shown in FIGS. 1-3, the unactivated biomass-based carbonaceous particulate material may be uniformly distributed and uniformly dispersed throughout the thermoplastic foam. It is to be appreciated that FIGS. 1-3 are images taken by a scanning electron microscope (SEM) of the thermoplastic foam composition. The unactivated biomass-based carbonaceous particulate material is uniformly distributed throughout the thermoplastic foam such that any given section of the thermoplastic foam composition has approximately the same concentration of the unactivated biomass-based carbonaceous particulate material. Moreover, the unactivated biomass-based carbonaceous particulate material has a D50 particle size, and the D50 particle size may have a unimodal particle size distribution such that the unactivated biomass-based particulate material is uniformly dispersed throughout the thermoplastic foam. Said differently, the unactivated biomass-based carbonaceous particulate material is free of agglomerates which would generate a bimodal particle size distribution.

The unactivated biomass-based carbonaceous particulate material may have a D50 particle size between 0.1 micron and 200 microns. The D50 particle size is representative of the average diameter of the unactivated biomass-based carbonaceous particulate material as measured pursuant to ISO 13320. Additionally, the unactivated biomass-based carbonaceous particulate material may have a D50 particle size between 0.2 microns and 200 microns, between 0.2 microns and 100 microns, between 0.2 microns and 50 microns, between 0.2 microns and 40 microns, between 0.2 microns and 30 microns, between 0.2 microns and 20 microns, between 0.2 microns and 15 microns, between 0.2 microns and 12.5 microns, and between 0.2 microns and 8 microns. Additionally, the unactivated biomass-based carbonaceous particulate material may have a D50 particle size between 1 micron and 200 microns, between 1 micron and 100 microns, between 1 micron and 50 microns, between 1 micron and 40 microns, between 1 micron and 30 microns, between 1 micron and 20 microns, between 1 micron and 15 microns, between 1 micron and 8 microns, about 1 micron, about 2 microns, about 3 microns, about 4 microns, about 5 microns, about 6 microns, about 7 microns, about 8 microns, about 9 microns, about 10 microns, about 11 microns, about 12 microns, about 13 microns, about 14 microns, or about 15 microns. However, the unactivated biomass-based carbonaceous particulate material may even have an average diameter of less than 1 micron or greater than 100 microns.

The unactivated biomass-based carbonaceous particulate material may also have non-uniform particle sizes ranging from 1 micron to 50 microns, from 1 micron to 35 microns, or from 2 microns to 25 microns. Moreover, the unactivated biomass-based carbonaceous particulate material may have a D50 particle size between 1 micron and 6 microns, between 1.5 microns and 6 microns, between 2 microns and 6 microns, between 2.5 microns and 6 microns, between 3 microns and 6 microns, between 3.5 microns and 6 microns, between 4 microns and 6 microns, between 4.5 microns and 6 microns, and between 5 microns and 6 microns. Smaller particle sizes of the unactivated biomass-based carbonaceous particulate material tend to increase fusibility of the thermoplastic foam composition.

The unactivated biomass-based carbonaceous particulate material may have a percentage of modern carbon (pMC) greater than 75% as measured pursuant to ASTM D6866. It is to be appreciated that the unactivated biomass-based carbonaceous particulate material may have a percentage of modern carbon (pMC) greater than 75%. As non-limiting examples, the unactivated biomass-based carbonaceous particulate material may have a percentage of modern carbon (pMC) greater than 80% as measured pursuant to ASTM D6866, the unactivated biomass-based carbonaceous particulate material may have a percentage of modern carbon (pMC) greater than 85% as measured pursuant to ASTM D6866, the unactivated biomass-based carbonaceous particulate material may have a percentage of modern carbon (pMC) greater than 90% as measured pursuant to ASTM D6866, the unactivated biomass-based carbonaceous particulate material may have a percentage of modern carbon (pMC) greater than 95% as measured pursuant to ASTM D6866, and the unactivated biomass-based carbonaceous particulate material may have a percentage of modern carbon (pMC) of approximately 100% as measured pursuant to ASTM D6866. In a non-limiting example, the unactivated biomass-based carbonaceous particulate material has a percentage of modern carbon (pMC) greater than 75%, an ash content less than 12%, and a nitrogen level less than 2%.

The thermoplastic foam may be further defined as an expanded thermoplastic foam formed via a blowing agent. The expanded thermoplastic foam may be formed through foaming with the blowing agent in an autoclave. However, it is also to be appreciated that the thermoplastic foam may be formed directly through extrusion with an extruder.

The thermoplastic foam composition may be self-extinguishing. Furthermore, although not required, the thermoplastic foam composition is preferably free of a flame-retardant other than the unactivated biomass-based carbonaceous particulate material. Although the unactivated biomass-based carbonaceous particulate material is itself combustible, it has been found that the thermoplastic foam composition including the thermoplastic foam and the unactivated biomass-based carbonaceous particulate material exhibits a flame-retardant effect. As a non-limiting example, a molded article having a core density of 18 grams per liter and 5 percent by weight unactivated biomass-based carbonaceous particulate material was found to be self-extinguishing. The thermoplastic foam composition may also be non-conductive to electricity.

The thermoplastic foam may define cells having a unimodal cell structure distribution, as shown in FIGS. 1-3. The unimodal cell structure distribution results in a uniform cell structure which assists in maintaining the dimensional stability and the mechanical properties of the thermoplastic foam composition. It has been found that the encapsulation of the unactivated biomass-based carbonaceous particulate material in the thermoplastic foam has both generated a unimodal cell structure distribution, resulting in a uniform cell structure, while also limiting the average size of the cells.

The cells may have an average size of less than 200 microns. The cells may also have an average size of less than 150 microns, less than 100 microns, less than 75 microns, or of less than 50 microns. Limiting the average size of the cells further assists in maintaining the dimensional stability and the mechanical properties of the thermoplastic foam composition. Additionally, the cells may have an average size of between 1 micron and 200 microns, between 10 microns and 200 microns, between 10 microns and 150 microns, between 10 microns and 100 microns, between 20 microns and 100 microns, between 20 microns and 75 microns, and between 20 microns and 50 microns.

The thermoplastic foam may be substantially free of a cell nucleating agent other than the unactivated biomass-based carbonaceous particulate material. The thermoplastic foam may be substantially free of a cell nucleating agent by including less than 1 percent by weight of cell nucleating agent. The unactivated biomass-based carbonaceous particulate material may act as a nucleating agent for both isothermal crystallization and cell development. However, it is clear that the unactivated biomass-based carbonaceous particulate material is not too strong of a cell nucleating agent, such as other additives (e.g., talc) are, which interfere with expansion of the cells and preclude formation of low-density thermoplastic foam compositions. Additionally, although the unactivated biomass-based carbonaceous particulate material may promoted cell nucleation, it may hinder cell growth during foaming. Accordingly, as the unactivated biomass-based carbonaceous particulate material is solid and does not contribute positively to expansion during foaming, the thermoplastic foam composition having both low-density and high-stiffness was a remarkable achievement.

As described herein, the thermoplastic foam composition has a core density of between 12 grams per liter and 400 grams per liter as measured pursuant to ASTM-D3575-W Test Method A. The thermoplastic foam composition may also have a core density of between 12 grams per liter and 300 grams per liter, of between 12 grams per liter and 250 grams per liter, of between 12 grams per liter and 200 grams per liter, of between 12 grams per liter and 150 grams per liter, of between 12 grams per liter and 100 grams per liter, of between 12 grams per liter and 80 grams per liter, of between 12 grams per liter and 68 grams per liter, of between 12 grams per liter and 67.3 grams per liter, and of between 12 grams per liter and 45 grams per liter. The core densities enumerated herein are exemplary for low-density articles.

As also described herein, the thermoplastic foam composition has an elastic modulus of between 60 pounds per square inch and 3500 pounds per square inch as measured pursuant to ASTM-C203 Method I, Equation 13. The thermoplastic foam composition may also have an elastic modulus of between 60 pounds per square inch and 2500 pounds per square inch, between 60 pounds per square inch and 2000 pounds per square inch, between 60 pounds per square inch and 1000 pounds per square inch, between 200 pounds per square inch and 2200 pounds per square inch, between 250 pounds per square inch and 3500 pounds per square inch, between 500 pounds per square inch and 3500 pounds per square inch, between 600 pounds per square inch and 3500 pounds per square inch, between 1000 pounds per square inch and 3500 pounds per square inch, between 240 pounds per square inch and 2100 pounds per square inch, between 300 pounds per square inch and 2100 pounds per square inch, between 400 pounds per square inch and 2000 pounds per square inch, between 400 pounds per square inch and 1500 pounds per square inch, between 400 pounds per square inch and 1000 pounds per square inch, between 400 pounds per square inch and 800 pounds per square inch, or about 600 pounds per square inch. It is to be appreciated that the thermoplastic foam composition may have an elastic modulus of at least 600 pounds per square inch, preferably of at least 700 pounds per square inch.

The elastic modulus of the thermoplastic foam composition may be at least 10% greater than that of a reference thermoplastic foam having the thermoplastic foam of the thermoplastic foam composition but which omits the unactivated biomass-based carbonaceous particulate material, as measured pursuant to ASTM-C203 Method I, Equation 13. As described herein, the encapsulation of unactivated biomass-based carbonaceous particulate material increases the elastic modulus of the thermoplastic foam composition, thus stiffening the thermoplastic foam composition. The elastic modulus of the thermoplastic foam composition may also be at least 15% greater than that of a reference thermoplastic foam having the thermoplastic foam of the thermoplastic foam composition but which omits the unactivated biomass-based carbonaceous particulate material, as measured pursuant to ASTM-C203 Method I, Equation 13. The elastic modulus of the thermoplastic foam composition may even be at least 20% greater than that of a reference thermoplastic foam having the thermoplastic foam of the thermoplastic foam composition but which omits the unactivated biomass-based carbonaceous particulate material, as measured pursuant to ASTM-C203 Method I, Equation 13.

Additionally, the unactivated biomass-based carbonaceous particulate material improves the elastic modulus of the thermoplastic foam composition while simultaneously improving or maintaining other desirable mechanical properties of the thermoplastic foam composition as compared to typical thermoplastic foams including carbon black. Often, the addition of additives to typical thermoplastic foams has a noticeable negative impact on the mechanical properties of the typical thermoplastic foams. However, the encapsulation of unactivated biomass-based carbonaceous particulate material was unexpectedly found to maintain these other desirable mechanical properties.

As a non-limiting example of the mechanical properties of the thermoplastic foam composition, the thermoplastic foam composition may have a compression set percentage at 25% strain which is within 25% as that of the reference thermoplastic foam which omits the unactivated biomass-based carbonaceous particulate material, as measured pursuant to ASTM-D3575-B. The thermoplastic foam composition may also have a compression set percentage at 25% strain which is within 20%, 15%, 10%, or even 5% as that of the reference thermoplastic foam which omits the unactivated biomass-based carbonaceous particulate material, as measured pursuant to ASTM-D3575-B.

As another non-limiting example of the mechanical properties of the thermoplastic foam composition, the thermoplastic foam composition may have a flexural strength which is within 10% as that of the reference thermoplastic foam which omits the unactivated biomass-based carbonaceous particulate material, as measured pursuant to ASTM-C203. The thermoplastic foam composition may also have a flexural strength which is within 5% as that of the reference thermoplastic foam which omits the unactivated biomass-based carbonaceous particulate material, as measured pursuant to ASTM-C203. The flexural strength of the thermoplastic foam composition may be between 5 pounds per square inch and 125 pounds per square inch, between 5 pounds per square inch and 60 pounds per square inch, between 6 pounds per square inch and 110 pounds per square inch, between 6 pounds per square inch and 80 pounds per square inch, between 6 pounds per square inch and 50 pounds per square inch, between 7 pounds per square inch and 40 pounds per square inch, between 8 pounds per square inch and 50 pounds per square inch, between 8 pounds per square inch and 30 pounds per square inch, between 9 pounds per square inch and 25 pounds per square inch, and between 10 pounds per square inch and 20 pounds per square inch.

As another non-limiting example of the mechanical properties of the thermoplastic foam composition, the thermoplastic foam composition may have a compressive strength at 50% strain of at least 40 kilopascals as measured pursuant to ASTM-D3575-D. The thermoplastic foam composition may also have a compressive strength at 50% strain of at least 60 kilopascals as measured pursuant to ASTM-D3575-D, of at least 80 kilopascals as measured pursuant to ASTM-D3575-D, of at least 100 kilopascals as measured pursuant to ASTM-D3575-D, of at least 150 kilopascals as measured pursuant to ASTM-D3575-D, of at least 200 kilopascals as measured pursuant to ASTM-D3575-D, or of at least 250 kilopascals as measured pursuant to ASTM-D3575-D. The thermoplastic foam composition may even have a compressive strength at 50% strain of at least 300 kilopascals as measured pursuant to ASTM-D3575-D. The thermoplastic foam composition has a compressive strength at 50% strain of 40 kilopascals to 4100 kilopascals, of 60 kilopascals to 3000 kilopascals, of 100 kilopascals to 2000 kilopascals, of 150 kilopascals to 1000 kilopascals, of 200 kilopascals to 600 kilopascals, of 250 kilopascals to 400 kilopascals, of 300 kilopascals to 350 kilopascals, of about 300 kilopascals, of about 325 kilopascals, or of about 350 kilopascals.

As another non-limiting example of the mechanical properties of the thermoplastic foam composition, the thermoplastic foam composition has a compressive strength at 75% strain of 200 kilopascals to 13500 kilopascals, of 310 kilopascals to 10000 kilopascals, of 310 kilopascals to 5000 kilopascals, of 310 kilopascals to 3000 kilopascals, of 310 kilopascals to 2000 kilopascals, of 310 kilopascals to 1000 kilopascals, of 400 kilopascals to 800 kilopascals, of 600 kilopascals to 800 kilopascals, of 650 kilopascals to 750 kilopascals, or of about 700 kilopascals.

As another non-limiting example of the mechanical properties of the thermoplastic foam composition, the thermoplastic foam composition has a tensile strength between 200 kilopascals and 2800 kilopascals, between 200 and 650 kilopascals, between 260 kilopascals and 2000 kilopascals, between 260 kilopascals and 1500 kilopascals, between 300 kilopascals and 1000 kilopascals, between 400 kilopascals and 800 kilopascals, between 500 kilopascals and 700 kilopascals, between 550 kilopascals to 650 kilopascals, or about 600 kilopascals.

As another non-limiting example of the mechanical properties of the thermoplastic foam composition, the thermoplastic foam composition has an elongation at break of between 2% and 150%, between 2% and 25%, between 5% and 25%, between 10% and 150%, between 50% and 150%, between 100% and 150%, between 10% and 25%, between 15% and 25%, between 15% and 20%, of about 15%, or about 20%.

The thermoplastic foam may include a thermoplastic polyolefin (TPO) such as a polyalkylene, including both linear polymers, branched polymers, or combinations thereof. Although not required, the thermoplastic foam may include expanded polypropylene (EPP). The expanded polypropylene may be at least one chosen from an expanded polypropylene homopolymer, an expanded polypropylene (random or blocked) copolymer, and an expanded polypropylene terpolymer. In other words, the thermoplastic foam may be the expanded polypropylene homopolymer, the expanded polypropylene copolymer, the expanded polypropylene terpolymer, or combinations thereof. In non-limiting examples, the thermoplastic foam may be high density expanded polypropylene (HDPP), medium density expanded polypropylene, or low density expanded polypropylene (LDPP). Although not required, higher weight percentages of unactivated biomass-based carbonaceous particulate material may be used in high density polypropylene as compared to low density polypropylene.

In the embodiments where the thermoplastic foam is either the expanded polypropylene copolymer or the expanded polypropylene terpolymer, the thermoplastic foam may include propylene monomeric units and at least one chosen from ethylene monomeric units and butylene monomeric units or other alpha-olefin monomeric units. As a non-limiting example, the expanded polypropylene terpolymer may be expanded ethylene propylene 1-butylene terpolymer.

In embodiments where the expanded polypropylene includes propylene monomeric units and at least one of the ethylene monomeric units and the butylene monomeric units and other alpha-olefin monomeric units, the propylene monomeric units, the ethylene monomeric units, the butylene monomeric units, and/or the other alpha-olefin monomeric units may be arranged in a random configuration or in an arranged configuration. More specifically, the propylene monomeric units, the ethylene monomeric units, the butylene monomeric units, and/or the other alpha-olefin monomeric units may have either a random or a regular repeating pattern in the carbon backbone of the expanded polymer. Moreover, the tacticity of the propylene monomeric units, the ethylene monomeric units, the butylene monomeric units, and/or the other alpha-olefin monomeric units may be arranged in an atactic configuration where repeating monomeric units lack regularity or coordination in their stereochemical orientation in the carbon backbone of the expanded polymer, may be arranged in a syndiotactic configuration where repeating monomeric units have regular alternation of different stereochemical orientations in the carbon backbone of the expanded polymer, or may be arranged in an isotactic configuration where all repeating monomeric units have the same stereochemical orientation in the carbon backbone of the expanded polymer. It is to be appreciated that even the expanded polypropylene homopolymer may be arranged in either of the atactic, syndiotactic, or isotactic configurations.

The expanded polypropylene may include at least 50 percent by weight of a random copolymer of polypropylene and between 5 percent by weight and 30 percent by weight of ethylene propylene rubber. The expanded polypropylene may also include polyolefin elastomers and/or plastomers such as Engage™ by Dow. The expanded polypropylene may be recycled material, or may be virgin material. The expanded polypropylene may have a core density of between 12 grams per liter and 68 grams per liter as measured pursuant to ASTM-D3575-W Test Method A. Additionally, the expanded polypropylene may have a core density of between 16 grams per liter and 68 grams per liter as measured pursuant to ASTM-D3575-W Test Method A, may have a core density of between 12 grams per liter and 67.3 grams per liter as measured pursuant to ASTM-D3575-W Test Method A, may have a core density of between 16 grams per liter and 50 grams per liter as measured pursuant to ASTM-D3575-W Test Method A, may have a core density of between 16 grams per liter and 45 grams per liter as measured pursuant to ASTM-D3575-W Test Method A, or may have a core density of between 20 grams per liter and 45 grams per liter as measured pursuant to ASTM-D3575-W Test Method A. The core densities enumerated herein are exemplary for low-density articles.

Moreover, the thermoplastic foam may include a thermoplastic elastomer obtained by polycondensation of a carboxylic acid polyamide with an alcohol terminated polyether. The thermoplastic elastomer obtained by polycondensation of a carboxylic acid polyamide with an alcohol terminated polyether may be Pebax sold by Arkema. The carboxylic acid polyamide may be, but is not limited to, Nylon 6 (PA6), Nylon 11 (PA11), and Nylon 12 (PA12), and the alcohol terminated polyether may be, but is not limited to, polytetramethylene glycol (PTMG) or polyethylene glycol (PEG).

As disclosed herein, the thermoplastic foam may be a polyolefin, such as the expanded polypropylene. It is also contemplated that the thermoplastic foam may be other polyolefins, such as low-density polyethylene (LDPE), linear low-density polyethylene (LLDPE), very low-density polyethylene (VLDPE), ultra-low-density polyethylene (ULDPE), medium-density polytheylene (MDPE), polybutene-1 (PB-1), ethylene-octene copolymers, stereo-block polypropylene, olefin block copolymers, propylene-butane copolymers, ethylene vinyl acetate copolymer (EVA), polyolefin elastomers (POE), or poly(a-olefin) s. However, the thermoplastic foam need not include a polyolefin (e.g., expanded polypropylene). As non-limiting examples, it is also contemplated that the thermoplastic foam may include thermoplastic polyurethane (TPU), polyamide (PA) such as Nylon, polymethylpentene (PMP), polyisobutylene (PIB), styrene-butadiene block copolymer and hydrogenated products of the above, polyesters including but not limited to polyethylene terephthalate (PET) and polybutylene terephthalate (PBT), polycarbonate (PC), bioplastics including but not limited to polylactic acid and polylactide (PLA), polybutylene adipate terephthalate (PBAT), poly(butylene succinate-co-butylene adipate) (PBSA), polycaprolactone (PCL), polyhydroalkanoates (PHA), poly(3-hydroxybutyrate) (PHBH), poly(p-phenylene oxide) or poly(p-phenylene ether) (PPE) including blends with polystyrene or high impact styrene-butadiene copolymer or polyamide, styrene polymers including polystyrene, expandable polystyrene, styrene-acrylonitrile copolymer, styrene-methyl methacrylate copolymer, acrylonitrile-butadiene-styrene copolymer (ABS), and acrylonitrile-styrene-acrylate copolymer including blends with polyphenylene ether (PPE) and/or polycarbonate (PC), styrene methyl methacrylate (SMMA), styrene-acrylonitrile (SAN), methyl methacrylate-acrylonitrile-butadiene-styrene (MABS), styrene butadiene block copolymer (SBC), methyl methacrylate-butadiene-styrene (MBS), and styrene-ethylene-butylene-styrene (SEBS).

The thermoplastic foam composition may further include additives, for example additives configured to avoid thermal degradation of the thermoplastic foam composition during extrusion or during foaming in an autoclave, or for example additional colorants, stabilizers such as ultraviolet stabilizers, anti-static agents, fire retardants, metal-deactivators, pigments, fillers, lubricants, and other carbon-based fillers including but not limited to graphene, graphite, and expandable graphite. Additionally, the thermoplastic foam composition may include resins useful for improving the foaming of the thermoplastic foam composition, and/or may include coupling agents for better mixing and dispersion.

Also provided herein is a thermoplastic polyurethane foam composition for low-density and high-stiffness articles. The thermoplastic polyurethane foam composition includes a thermoplastic polyurethane foam and a biomass-based carbonaceous particulate material encapsulated in the thermoplastic polyurethane foam. The thermoplastic polyurethane foam composition has a core density of between 80 grams per liter and 400 grams per liter as measured pursuant to ASTM-D3575-W Test Method A. The thermoplastic polyurethane foam composition also has an elastic modulus of between 60 pounds per square inch and 700 pounds per square inch as measured pursuant to ASTM-C203 Method I, Equation 13.

The biomass-based carbonaceous particulate material is a non-petroleum-based additive, is a renewable resource and is sustainable, has a low global warming potential (GWP), and leaves a low carbon footprint. More specifically, the biomass-based carbonaceous particulate material has a low carbon footprint because the biomass from which the biomass-based carbonaceous particular material is derived has sequestered carbon dioxide from the atmosphere during its life. Moreover, the biomass-based carbonaceous particulate material is suitable for encapsulation in foam to provide a low-density article, while also modulating the elastic modulus of the foam to provide a high-stiffness article. The biomass-based carbonaceous particulate material may be a colorant that provides color to the thermoplastic polyurethane foam and may be an ultraviolet (UV) stabilizer that protects the thermoplastic polyurethane foam from degradation resulting from exposure to ultraviolet energy.

The biomass-based carbonaceous particulate material is derived from a biomass feedstock that has been subjected to pyrolysis including, but not limited to, tree material (e.g. wood, wood chips, and/or leaves) from coniferous and/or deciduous trees, including acer trees, more specifically acer psuedoplatanus trees including both wood, wood chips, and/or leaves therefrom, which are some of the most common maple foliage's in Europe, nut shells (e.g. coconut shells, walnut shells, hazelnut shells, peanut shells, etc.), bamboo, rice hulls, grasses, corn stover, plant matter, seeds, paper, cardboard, manure, other agricultural residues, biorefinery residues, sorghum, dried algae, coffee beans, coffee grounds, grounds, sugar cane bagasse, and any combination thereof, among other possibilities.

The biomass-based carbonaceous particulate material is porous. The porosity of the biomass-based carbonaceous particulate material may be greater than 50%, greater than 55%, greater than 60%, greater than 65%, greater than 70%, greater than 75%, greater than 80%, greater than 85%, greater than 90%, or greater than 95%. The porosity of the biomass-based carbonaceous particulate material may be between 50% and 90%, between 60% and 80%, between 65% and 75%, or about 70%. It is to be appreciated that the porosity of the biomass-based carbonaceous particulate material varies dependent upon the particular biomass from which the biomass-based carbonaceous particulate material is derived.

Notably, in the embodiment disclosing the thermoplastic polyurethane foam composition, the biomass-based carbonaceous particulate material need not be unactivated. Instead, both activated biomass-based carbonaceous particulate material and unactivated biomass-based carbonaceous particulate material are contemplated as suitable for encapsulation in the thermoplastic polyurethane foam. The biomass-based carbonaceous particulate material may have a specific surface area of between 150 square meters per gram of the biomass-based carbonaceous particulate material and 2000 square meters per gram of the biomass-based carbonaceous particulate material.

The biomass-based carbonaceous particulate material may be further defined as an unactivated biomass-based carbonaceous particulate material, and the unactivated biomass-based carbonaceous particulate material may have a specific surface area of between 150 square meters per gram of the unactivated biomass-based carbonaceous particulate material and 495 square meters per gram of the unactivated biomass-based carbonaceous particulate material. The unactivated biomass-based carbonaceous particulate material may have a specific surface area of between 190 square meters per gram of the unactivated biomass-based carbonaceous particulate material and 495 square meters per gram of the unactivated biomass-based carbonaceous particulate material, may have a specific surface area of between 200 square meters per gram of the unactivated biomass-based carbonaceous particulate material and 450 square meters per gram of the unactivated biomass-based carbonaceous particulate material, may have a specific surface area of between 200 square meters per gram of the unactivated biomass-based carbonaceous particulate material and 400 square meters per gram of the unactivated biomass-based carbonaceous particulate material, may have a specific surface area of between 200 square meters per gram of the unactivated biomass-based carbonaceous particulate material and 350 square meters per gram of the unactivated biomass-based carbonaceous particulate material, or may have a specific surface area of between 200 square meters per gram of the unactivated biomass-based carbonaceous particulate material and 300 square meters per gram of the unactivated biomass-based carbonaceous particulate material.

Alternatively, the biomass-based carbonaceous particulate material may be further defined as an activated biomass-based carbonaceous particulate material, and the activated biomass-based carbonaceous particulate material has a specific surface area of between 495 square meters per gram of the activated biomass-based carbonaceous particulate material and 2000 square meters per gram of the activated biomass-based carbonaceous particulate material. The activated biomass-based carbonaceous particulate material may have a specific surface area of between 495 square meters per gram of the activated biomass-based carbonaceous particulate material and 1500 square meters per gram of the activated biomass-based carbonaceous particulate material, between 495 square meters per gram of the activated biomass-based carbonaceous particulate material and 1200 square meters per gram of the activated biomass-based carbonaceous particulate material, or between 495 square meters per gram of the activated biomass-based carbonaceous particulate material and 1000 square meters per gram of the activated biomass-based carbonaceous particulate material. The activated biomass-based carbonaceous particulate material is treated, such as with steam and/or chemical treatment(s).

Moreover, the thermoplastic polyurethane foam composition may be recyclable. Although the thermoplastic polyurethane foam composition may include cross-links, these cross-links are not to such an extent that the thermoplastic polyurethane foam is a thermoset material.

The biomass-based carbonaceous particulate material may be between 0.1 percent by weight and 25 percent by weight of the thermoplastic polyurethane foam composition. Moreover, the biomass-based carbonaceous particulate material may be between 0.5 percent by weight and 20 percent by weight of the thermoplastic polyurethane foam composition, between 0.5 percent by weight and 15 percent by weight of the thermoplastic polyurethane foam composition, between 0.5 percent by weight and 12 percent by weight of the thermoplastic polyurethane foam composition, between 0.5 percent by weight and 10 percent by weight of the thermoplastic polyurethane foam composition, between 0.5 percent by weight and 8 percent by weight of the thermoplastic polyurethane foam composition, between 0.5 percent by weight and 6 percent by weight of the thermoplastic polyurethane foam composition, between 0.5 percent by weight and 5 percent by weight of the thermoplastic polyurethane foam composition, between 0.5 percent by weight and 4 percent by weight of the thermoplastic polyurethane foam composition, between 0.5 percent by weight and 3 percent by weight of the thermoplastic polyurethane foam composition, between 0.5 percent by weight and 2 percent by weight of the thermoplastic polyurethane foam composition, and between 0.5 percent by weight and 1 percent by weight of the thermoplastic polyurethane foam composition. Additionally, the biomass-based carbonaceous particulate material may be between 1 percent by weight and 20 percent by weight of the thermoplastic polyurethane foam composition, between 1 percent by weight and 15 percent by weight of the thermoplastic polyurethane foam composition, between 1 percent by weight and 12 percent by weight of the thermoplastic polyurethane foam composition, between 1 percent by weight and 10 percent by weight of the thermoplastic polyurethane foam composition, between 1 percent by weight and 8 percent by weight of the thermoplastic polyurethane foam composition, between 1 percent by weight and 6 percent by weight of the thermoplastic polyurethane foam composition, between 1 percent by weight and 5 percent by weight of the thermoplastic polyurethane foam composition, between 1 percent by weight and 4 percent by weight of the thermoplastic polyurethane foam composition, between 1 percent by weight and 3 percent by weight of the thermoplastic polyurethane foam composition, and between 1 percent by weight and 2 percent by weight of the thermoplastic polyurethane foam composition.

Furthermore, the biomass-based carbonaceous particulate material may be between 2 percent by weight and 20 percent by weight of the thermoplastic polyurethane foam composition, between 2 percent by weight and 15 percent by weight of the thermoplastic polyurethane foam composition, between 2 percent by weight and 12 percent by weight of the thermoplastic polyurethane foam composition, between 2 percent by weight and 10 percent by weight of the thermoplastic polyurethane foam composition, between 2 percent by weight and 8 percent by weight of the thermoplastic polyurethane foam composition, between 2 percent by weight and 6 percent by weight of the thermoplastic polyurethane foam composition, between 2 percent by weight and 5 percent by weight of the thermoplastic polyurethane foam composition, between 2 percent by weight and 4 percent by weight of the thermoplastic polyurethane foam composition, and between 2 percent by weight and 3 percent by weight of the thermoplastic polyurethane foam composition. Further still, the biomass-based carbonaceous particulate material may be between 3 percent by weight and 20 percent by weight of the thermoplastic polyurethane foam composition, between 3 percent by weight and 15 percent by weight of the thermoplastic polyurethane foam composition, between 3 percent by weight and 12 percent by weight of the thermoplastic polyurethane foam composition, between 3 percent by weight and 10 percent by weight of the thermoplastic polyurethane foam composition, between 3 percent by weight and 8 percent by weight of the thermoplastic polyurethane foam composition, between 3 percent by weight and 6 percent by weight of the thermoplastic polyurethane foam composition, between 3 percent by weight and 5 percent by weight of the thermoplastic polyurethane foam composition, and between 3 percent by weight and 4 percent by weight of the thermoplastic polyurethane foam composition.

It is to be appreciated that the biomass-based carbonaceous particulate material may even be more than 20 percent by weight of the thermoplastic polyurethane foam composition. Although not required, the thermoplastic polyurethane foam is typically petroleum-based. It is to be appreciated that the biomass-based carbonaceous particulate material may supplant the thermoplastic polyurethane foam with respect to the relative weight percentages in the thermoplastic polyurethane foam composition. As such, higher weight percentages of the biomass-based carbonaceous particulate material in the thermoplastic polyurethane foam composition reduce the relative weight percentage of the thermoplastic polyurethane foam in the thermoplastic polyurethane foam composition, thus further lowering the carbon footprint of the thermoplastic polyurethane foam composition.

Higher weight percentages of the biomass-based carbonaceous particulate material in the thermoplastic polyurethane foam composition do not increase the melt pressure and, if processed with an extruder, do not increase the extruder torque. As such, the encapsulation of the biomass-based carbonaceous particulate material in the thermoplastic polyurethane foam composition does not increase the energy consumption during extrusion. The encapsulation of the biomass-based carbonaceous particulate material in the thermoplastic polyurethane foam also had little to no significant effect on the viscosity or the rheological behavior of the thermoplastic polyurethane foam.

The biomass-based carbonaceous particulate material may be uniformly distributed and uniformly dispersed throughout the thermoplastic polyurethane foam. The biomass-based carbonaceous particulate material is uniformly distributed throughout the thermoplastic polyurethane foam such that any given section of the thermoplastic polyurethane foam composition has approximately the same concentration of the biomass-based carbonaceous particulate material. Moreover, the biomass-based carbonaceous particulate material has a D50 particle size, and the D50 particle size may have a unimodal particle size distribution such that the biomass-based particulate material is uniformly dispersed throughout the thermoplastic polyurethane foam. Said differently, the biomass-based carbonaceous particulate material is free of agglomerates which would generate a bimodal particle size distribution.

The biomass-based carbonaceous particulate material may have a D50 particle size between 0.1 micron and 200 microns. The D50 particle size is representative of the average diameter of the biomass-based carbonaceous particulate material as measured pursuant to ISO 13320. Additionally, the biomass-based carbonaceous particulate material may have a D50 particle size between 0.2 microns and 200 microns, between 0.2 microns and 100 microns, between 0.2 microns and 50 microns, between 0.2 microns and 40 microns, between 0.2 microns and 30 microns, between 0.2 microns and 20 microns, between 0.2 microns and 15 microns, between 0.2 microns and 12.5 microns, and between 0.2 microns and 8 microns. Additionally, the biomass-based carbonaceous particulate material may have a D50 particle size between 1 micron and 200 microns, between 1 micron and 100 microns, between 1 micron and 50 microns, between 1 micron and 40 microns, between 1 micron and 30 microns, between 1 micron and 20 microns, between 1 micron and 15 microns, between 1 micron and 8 microns, about 1 micron, about 2 microns, about 3 microns, about 4 microns, about 5 microns, about 6 microns, about 7 microns, about 8 microns, about 9 microns, about 10 microns, about 11 microns, about 12 microns, about 13 microns, about 14 microns, or about 15 microns. However, the biomass-based carbonaceous particulate material may even have an average diameter of less than 1 micron or greater than 100 microns.

The biomass-based carbonaceous particulate material may also have non-uniform particle sizes ranging from 1 micron to 50 microns, from 1 micron to 35 microns, or from 2 microns to 25 microns. Moreover, the biomass-based carbonaceous particulate material may have a D50 particle size between 1 micron and 6 microns, between 1.5 microns and 6 microns, between 2 microns and 6 microns, between 2.5 microns and 6 microns, between 3 microns and 6 microns, between 3.5 microns and 6 microns, between 4 microns and 6 microns, between 4.5 microns and 6 microns, and between 5 microns and 6 microns. Smaller particle sizes of the biomass-based carbonaceous particulate material tend to increase fusibility of the thermoplastic polyurethane foam composition.

The biomass-based carbonaceous particulate material may have a percentage of modern carbon (pMC) greater than 75% as measured pursuant to ASTM D6866. It is to be appreciated that the biomass-based carbonaceous particulate material may have a percentage of modern carbon (pMC) greater than 75%. As non-limiting examples, the biomass-based carbonaceous particulate material may have a percentage of modern carbon (pMC) greater than 80% as measured pursuant to ASTM D6866, the biomass-based carbonaceous particulate material may have a percentage of modern carbon (pMC) greater than 85% as measured pursuant to ASTM D6866, the biomass-based carbonaceous particulate material may have a percentage of modern carbon (pMC) greater than 90% as measured pursuant to ASTM D6866, the biomass-based carbonaceous particulate material may have a percentage of modern carbon (pMC) greater than 95% as measured pursuant to ASTM D6866, and the biomass-based carbonaceous particulate material may have a percentage of modern carbon (pMC) of approximately 100% as measured pursuant to ASTM D6866. In a non-limiting example, the biomass-based carbonaceous particulate material has a percentage of modern carbon (pMC) greater than 75%, an ash content less than 12%, and a nitrogen level less than 2%.

The thermoplastic polyurethane foam may be further defined as an expanded thermoplastic polyurethane foam formed via a blowing agent. The expanded thermoplastic polyurethane foam may be formed through foaming with the blowing agent in the autoclave. However, it is also to be appreciated that the thermoplastic polyurethane foam may be formed directly through extrusion with the extruder.

The thermoplastic polyurethane foam composition may be self-extinguishing. Furthermore, although not required, the thermoplastic polyurethane foam composition is preferably free of a flame-retardant other than the biomass-based carbonaceous particulate material. Although the biomass-based carbonaceous particulate material is itself combustible, it has been found that the thermoplastic polyurethane foam composition including the thermoplastic polyurethane foam and the biomass-based carbonaceous particulate material exhibits a flame-retardant effect. The thermoplastic polyurethane foam composition may also be non-conductive to electricity.

The thermoplastic polyurethane foam may define cells having a unimodal cell structure distribution. The unimodal cell structure distribution results in a uniform cell structure which assists in maintaining the dimensional stability and the mechanical properties of the thermoplastic polyurethane foam composition. It has been found that the encapsulation of the biomass-based carbonaceous particulate material in the thermoplastic polyurethane foam has both generated a unimodal cell structure distribution, resulting in a uniform cell structure, while also limiting the average size of the cells.

The cells may have an average size of less than 200 microns. The cells may also have an average size of less than 150 microns, less than 100 microns, less than 75 microns, or of less than 50 microns. Limiting the average size of the cells further assists in maintaining the dimensional stability and the mechanical properties of the thermoplastic polyurethane foam composition. Additionally, the cells may have an average size of between 1 micron and 200 microns, between 10 microns and 200 microns, between 10 microns and 150 microns, between 10 microns and 100 microns, between 20 microns and 100 microns, between 20 microns and 75 microns, and between 20 microns and 50 microns.

The thermoplastic polyurethane foam may be free of a cell nucleating agent other than the biomass-based carbonaceous particulate material. The thermoplastic polyurethane foam may be substantially free of a cell nucleating agent by including less than 1 percent by weight of cell nucleating agent. The biomass-based carbonaceous particulate material may act as a nucleating agent for both isothermal crystallization and cell development. However, it is clear that the biomass-based carbonaceous particulate material is not too strong of a cell nucleating agent, such as other additives (e.g., talc) are, which interfere with expansion of the cells and preclude formation of low-density thermoplastic polyurethane foam compositions. Additionally, although the biomass-based carbonaceous particulate material may promoted cell nucleation, it may hinder cell growth during foaming. Accordingly, as the biomass-based carbonaceous particulate material is solid and does not contribute positively to expansion during foaming, the thermoplastic polyurethane foam composition having both low-density and high-stiffness was a remarkable achievement.

As described herein, the thermoplastic polyurethane foam composition has a core density of between 80 grams per liter and 400 grams per liter as measured pursuant to ASTM-D3575-W Test Method A. The thermoplastic polyurethane foam composition may also have a core density of between 100 grams per liter and 300 grams per liter, of between 150 grams per liter and 250 grams per liter, of between 100 grams per liter and 200 grams per liter, and of between 100 grams per liter and 150 grams per liter. The core densities enumerated herein are exemplary for low-density articles.

As also described herein, the thermoplastic polyurethane foam composition has an elastic modulus of between 60 pounds per square inch and 700 pounds per square inch as measured pursuant to ASTM-C203 Method I, Equation 13. The thermoplastic polyurethane foam composition may also have an elastic modulus of between 60 pounds per square inch and 500 pounds per square inch, between 80 pounds per square inch and 400 pounds per square inch, between 100 pounds per square inch and 350 pounds per square inch, or between 150 pounds per square inch and 300 pounds per square inch. It is to be appreciated that the thermoplastic polyurethane foam composition may have an elastic modulus of at least 100 pounds per square inch.

The elastic modulus of the thermoplastic polyurethane foam composition may be at least 10% greater than that of a reference thermoplastic polyurethane foam having the thermoplastic polyurethane foam of the thermoplastic polyurethane foam composition but which omits the biomass-based carbonaceous particulate material, as measured pursuant to ASTM-C203 Method I, Equation 13. As described herein, the encapsulation of biomass-based carbonaceous particulate material increases the elastic modulus of the thermoplastic polyurethane foam composition, thus stiffening the thermoplastic polyurethane foam composition. The elastic modulus of the thermoplastic polyurethane foam composition may also be at least 15% greater than that of a reference thermoplastic polyurethane foam having the thermoplastic polyurethane foam of the thermoplastic polyurethane foam composition but which omits the biomass-based carbonaceous particulate material, as measured pursuant to ASTM-C203 Method I, Equation 13. The elastic modulus of the thermoplastic polyurethane foam composition may even be at least 20% greater than that of a reference thermoplastic polyurethane foam having the thermoplastic polyurethane foam of the thermoplastic polyurethane foam composition but which omits the biomass-based carbonaceous particulate material, as measured pursuant to ASTM-C203 Method I, Equation 13.

Additionally, the biomass-based carbonaceous particulate material improves the elastic modulus of the thermoplastic polyurethane foam composition while simultaneously maintaining other desirable mechanical properties of the thermoplastic polyurethane foam composition as compared to typical thermoplastic polyurethane foams including carbon black. Often, the addition of additives to typical thermoplastic polyurethane foams has a noticeable negative impact on the mechanical properties of the typical thermoplastic polyurethane foams. However, the encapsulation of biomass-based carbonaceous particulate material was unexpectedly found to maintain these other desirable mechanical properties.

As a non-limiting example of the mechanical properties of the thermoplastic polyurethane foam composition, the thermoplastic polyurethane foam composition may have a compression set percentage at 25% strain which is within 25% as that of the reference thermoplastic polyurethane foam which omits the biomass-based carbonaceous particulate material, as measured pursuant to ASTM-D3575-B. The thermoplastic polyurethane foam composition may also have a compression set percentage at 25% strain which is within 20%, 15%, 10%, or even 5% as that of the reference thermoplastic polyurethane foam which omits the biomass-based carbonaceous particulate material, as measured pursuant to ASTM-D3575-B.

As another non-limiting example of the mechanical properties of the thermoplastic polyurethane foam composition, the thermoplastic polyurethane foam composition may have a flexural strength which is within 10% as that of the reference thermoplastic polyurethane foam which omits the biomass-based carbonaceous particulate material, as measured pursuant to ASTM-C203. The thermoplastic polyurethane foam composition may also have a flexural strength which is within 5% as that of the reference thermoplastic polyurethane foam which omits the biomass-based carbonaceous particulate material, as measured pursuant to ASTM-C203. The flexural strength of the thermoplastic polyurethane foam composition may be between 5 pounds per square inch and 80 pounds per square inch, between 5 pounds per square inch and 60 pounds per square inch, between 6 pounds per square inch and 50 pounds per square inch, between 7 pounds per square inch and 40 pounds per square inch, between 8 pounds per square inch and 30 pounds per square inch, between 9 pounds per square inch and 25 pounds per square inch, and between 10 pounds per square inch and 20 pounds per square inch.

As another non-limiting example of the mechanical properties of the thermoplastic polyurethane foam composition, the thermoplastic polyurethane foam composition may have a compressive strength at 50% strain of at least 40 kilopascals as measured pursuant to ASTM-D3575-D. The thermoplastic polyurethane foam composition may also have a compressive strength at 50% strain of at least 60 kilopascals as measured pursuant to ASTM-D3575-D, of at least 80 kilopascals as measured pursuant to ASTM-D3575-D, of at least 100 kilopascals as measured pursuant to ASTM-D3575-D, of at least 150 kilopascals as measured pursuant to ASTM-D3575-D, of at least 200 kilopascals as measured pursuant to ASTM-D3575-D, or of at least 250 kilopascals as measured pursuant to ASTM-D3575-D. The thermoplastic polyurethane foam composition may even have a compressive strength at 50% strain of at least 300 kilopascals as measured pursuant to ASTM-D3575-D. The thermoplastic polyurethane foam composition has a compressive strength at 50% strain of 40 kilopascals to 1500 kilopascals, of 40 kilopascals to 1000 kilopascals, of 40 kilopascals to 800 kilopascals, of 40 kilopascals to 600 kilopascals, of 40 kilopascals to 500 kilopascals, of 60 kilopascals to 1500 kilopascals, of 100 kilopascals to 1500 kilopascals, of 150 kilopascals to 1000 kilopascals, of 200 kilopascals to 600 kilopascals, of 250 kilopascals to 400 kilopascals, of 300 kilopascals to 350 kilopascals, of about 300 kilopascals, of about 325 kilopascals, or of about 350 kilopascals.

As another non-limiting example of the mechanical properties of the thermoplastic polyurethane foam composition, the thermoplastic polyurethane foam composition has a compressive strength at 75% strain of 80 kilopascals to 13500 kilopascals, of 80 kilopascals to 3000 kilopascals, of 150 kilopascals to 3000 kilopascals, of 200 kilopascals to 3000 kilopascals, of 300 kilopascals to 3000 kilopascals, of 400 kilopascals to 3000 kilopascals, of 500 kilopascals to 3000 kilopascals, of 310 kilopascals to 10000 kilopascals, of 310 kilopascals to 5000 kilopascals, of 310 kilopascals to 3000 kilopascals, of 310 kilopascals to 2000 kilopascals, of 310 kilopascals to 1000 kilopascals, of 400 kilopascals to 800 kilopascals, of 600 kilopascals to 800 kilopascals, of 650 kilopascals to 750 kilopascals, of about 700 kilopascals, of about 800 kilopascals, of about 900 kilopascals, or of about 1000 kilopascals.

The thermoplastic polyurethane foam composition may further include additives, for example additives configured to avoid thermal degradation of the thermoplastic polyurethane foam composition during extrusion or during foaming in an autoclave, or for example additional colorants, stabilizers such as ultraviolet stabilizers, anti-static agents, fire retardants, metal-deactivators, pigments, fillers, lubricants, and other carbon-based fillers including but not limited to graphene, graphite, and expandable graphite. Additionally, the thermoplastic polyurethane foam composition may include resins useful for improving the foaming of the thermoplastic polyurethane foam composition, and/or may include coupling agents for better mixing and dispersion.

The thermoplastic foam composition, including the thermoplastic polyurethane foam composition, may be formed into beads or may be formed into an end product (e.g., the low-density and high-stiffness article). It is to be appreciated that the end product may be one component of a larger assembly. The end product may be for an automotive application. In non-limiting examples of automotive applications, the end product may be a seating substrate, a seat cushion, a headrest, a bumper core, an armrest, a trunk or cargo space component, a door panel component, a headliner component, a spacer, a load floor, or a battery case. It is also to be appreciated that the end product need not be an automotive application. In non-limiting examples of non-automotive applications, the end product may be a shoe component such as a shoe midsole or a shoe insole, a packaging tray, a protective packaging box, an industrial dunnage, and an industrial packaging. In the embodiments where the thermoplastic foam composition includes expanded polypropylene, the article may particularly be the seating substrate, or the trunk or cargo space component. The thermoplastic polyurethane foam composition may be particularly suitable for articles such as bumpers and shoe components such as shoe midsoles or shoe insoles.

It is to be appreciated that the unactivated biomass-based carbonaceous particulate material affects foamability, fusibility, and performance of the beads. The unactivated biomass-based carbonaceous particulate material also affects processability, cell morphology, thermal characteristics, and the final performance of the beads if subsequently formed into the end product. The thermoplastic foam composition may also include two separate crystal melting points. In other words, the thermoplastic foam composition may have a low crystal melting point and a high crystal melting point. The low crystal melting point and the high crystal melting point improve processability of the thermoplastic foam composition, as discussed below. Moreover, it has been found that the unactivated biomass-based carbonaceous particulate material may lower either the low crystal melting point of the thermoplastic foam composition, the high crystal melting point of the thermoplastic foam composition, or both the low crystal melting point and the high crystal melting point of the thermoplastic foam composition. As non-limiting examples, the low crystal melting point may be between 110 degrees Celsius and 150 degrees Celsius, and the high crystal melting point may be between 150 degrees Celsius and 170 degrees Celsius.

A method of manufacturing the thermoplastic foam composition is also provided. The method may include the step of extruding a thermoplastic material and the unactivated biomass-based carbonaceous particulate material encapsulated in the thermoplastic material. The thermoplastic material may be extruded directly as the thermoplastic foam. Alternatively, the method may include the step of expanding the thermoplastic material to form the thermoplastic foam and the unactivated biomass-based carbonaceous particulate material encapsulated in the thermoplastic foam.

The step of extruding the thermoplastic material may accomplished with an extruder including, but not limited to, a single screw extruder or twin-screw extruder. Although not required, the length to diameter of the extruder may be about 36:1 and the extruder may have a harsh screw geometry. The step of extruding the thermoplastic material melt blends the thermoplastic material and the unactivated biomass-based carbonaceous particulate material. The step of extruding the thermoplastic material may further include extruding various different particle sizes of the unactivated biomass-based carbonaceous particulate material, optionally in a plurality of different resins, and optionally with one or more additives. The relative weight percentage of unactivated biomass-based carbonaceous particulate material in the thermoplastic foam composition does not significantly impact rheological properties of the thermoplastic foam composition, such as viscosity, and thus does not significantly impact the melt pressure nor the extruder torque, and also thus does not increase the energy consumption of the extruder during the step of extruding the thermoplastic material. As such, the unactivated biomass-based carbonaceous particulate material does not negatively impact carbon dioxide emissions or the carbon footprint of the method. The step of extruding the thermoplastic material may include cooling the extruded thermoplastic material in a water bath and pelletizing the extruded thermoplastic material into pellets with a pelletizer. Pelletizing the extruded thermoplastic material into pellets with a pelletizer may be accomplished before the pellets contact the water bath. It is also to be appreciated that the step of extruding may form a film as thin as 40 microns.

The step of expanding the thermoplastic material to form the thermoplastic foam and the unactivated biomass-based carbonaceous particulate material encapsulated in the thermoplastic foam may be accomplished with the autoclave and may further include use of the blowing agent. The autoclave may be set at a temperature between about 80 degrees Celsius and about 250 degrees Celsius, between about 80 degrees Celsius and about 200 degrees Celsius, between about 100 degrees Celsius and about 180 degrees Celsius, between about 120 degrees Celsius and about 150 degrees Celsius, between about 125 degrees Celsius and about 140 degrees Celsius, between about 125 degrees Celsius and about 135 degrees Celsius, about 125 degrees Celsius, about 130 degrees Celsius, or about 135 degrees Celsius. The thermoplastic material may be disposed in the autoclave for between 1 minute to 2 hours, for 20 minutes to 1 hour, or for about 1 hour. The step of expanding the thermoplastic material to form the thermoplastic foam composition may also be accomplished under pressure. More specifically, the thermoplastic material may be under pressure, such as but not limited to between 200 pounds per square inch and 1200 pounds per square inch, between 500 pounds per square inch and 1100 pounds per square inch, between 600 pounds per square inch and 1000 pounds per square inch, between 700 pounds per square inch and 900 pounds per square inch, or about 800 pounds per square inch. The specific temperature and pressure associated with the step of expanding the thermoplastic material may be determined according the particular thermoplastic material to avoid risk of rupture of the thermoplastic material.

The step of expanding the thermoplastic material to form the thermoplastic foam composition may further include mixing the thermoplastic material with a suspension stabilizer, and optionally water, and may further include impregnating the thermoplastic material with a gas or a liquid, such as but not limited to carbon dioxide, nitrogen, or a combination thereof. The step of expanding the thermoplastic material may further include depressurizing the thermoplastic material so that the thermoplastic material expands to form the thermoplastic foam composition due to the thermodynamic instability created by the sharp pressure drop. Although not required, the step of expanding the thermoplastic material may be accomplished via two or more separate expansions, with each subsequent expansion further lowering the density of the thermoplastic foam composition. The step of expanding the thermoplastic material may further include washing the thermoplastic foam composition with water, optionally deionized water, to remove the suspension stabilizers if present.

The unactivated biomass-based carbonaceous particulate material may act as a cell nucleation site, such as a cell heterogeneous nucleating site, or as a nucleating agent for crystallization during the step of expanding the thermoplastic material to form the thermoplastic foam composition. As such, no additional additive may be required to serve as a nucleation site or a nucleating agent. Moreover, the unactivated biomass-based carbonaceous particulate material may act to limit the size of the cells defined by the thermoplastic foam composition, thus also increasing the uniformity of the cells. It is to be appreciated that the unactivated biomass-based carbonaceous particulate material is solid and may not act to increase the size of the cells during the step of expanding the thermoplastic material to form the thermoplastic foam composition. Thus, it is to be appreciated that the thermoplastic foam composition including the thermoplastic foam and the unactivated biomass-based carbonaceous particulate material encapsulated in the thermoplastic foam which also has a high elongation to break, a controlled rate of crystallization, and good rheological properties is a notable improvement. As described above, the thermoplastic foam composition may include other additives than unactivated biomass-based carbonaceous particulate material. In another non-limiting example, the thermoplastic foam composition may include other nucleating sites and/or other cell nucleating agents, which may be referred to as co-nucleating agents, for crystallization during the step of expanding to thermoplastic material to form the thermoplastic foam composition.

The step of expanding the thermoplastic material may be further defined as a step of expanding the pellets to form expanded beads. As such, the step of expanding the pellets may further include mixing the pellets with a suspension stabilizer, and optionally water, and may further include impregnating the pellets with a gas, such as but not limited to carbon dioxide, through pressurization of the pellets as described herein. The step of expanding the pellets may further include depressurizing the pellets so that the pellets expand to form the expanded bead including the thermoplastic foam and the unactivated biomass-based carbonaceous particulate material encapsulated in the thermoplastic foam. The pellets expand to form the expanded bead due to the thermodynamic instability created by the sharp pressure drop. The step of expanding the pellets may further include washing the expanded beads with water, optionally deionized water, to remove the suspension stabilizers if present.

The method may further include the step of forming the end product with the thermoplastic foam composition including the thermoplastic foam and the unactivated biomass-based carbonaceous particulate material encapsulated by the thermoplastic foam. The step of forming the end product may be accomplished with a press, such as but not limited to a steam chest press, a hydraulic press, or a resin press, to form the end product. Additionally or alternatively, the step of forming the end product may be accomplished through binding using a binder, such as a glue. The press may induce sintering of the thermoplastic foam composition. More specifically, in the embodiments where the expanded bead is formed, the expanded beads may be sintered. It is to be appreciated that utilizing a low steam pressurize with the press may further reduce the carbon footprint of the method. It is also to be appreciated that, depending upon the particular formulation of the thermoplastic foam composition and the particular processing parameters, the low crystal melting point of the thermoplastic foam composition may be lowered as compared to a similar composition containing carbon black instead of unactivated biomass-based carbonaceous particulate material, thus further lowering the carbon footprint of the method.

As described herein, the thermoplastic foam composition may include a low crystal melting point and a high crystal melting point, which may be collectively referred to as a double melt curve. More specifically, the expanded beads may include the low crystal melting point and the high crystal melting point. The step of forming the end product with the thermoplastic foam composition greatly benefits from the low crystal melting point and the high crystal melting point. More specifically, when the temperature of the press (e.g. the steam temperature) is selected during the step of forming the end product, the temperature of the press is advantageously between the low crystal melting point and the high crystal melting point, or the temperature of the press is advantageously below the high crystal melting point to ensure the structural integrity of the end product. As such, during the step of forming the end product, crystals with the low crystal melting point will melt, thus contributing to sintering of the thermoplastic foam composition, but crystals with the high crystal melting point will not melt, thus contributing to maintaining the overall shape of the end product. As a non-limiting example, a thermoplastic foam composition including an expanded ethylene propylene 1-butylene terpolymer and 10 percent by weight of unactivated biomass-based carbonaceous particulate material encapsulated in the expanded ethylene propylene 1-butylene terpolymer has a low crystal melting point and a high crystal melting point (i.e. a double melt curve), and thus the end product formed from the thermoplastic foam composition does not exhibit any sintering issues or dimensional stability issues.

While not intended to be bound by theory, it is contemplated that encapsulation of the unactivated biomass-based carbonaceous particulate material in the thermoplastic foam of the thermoplastic foam composition improves the dimensional stability of the thermoplastic foam composition. Typically, after forming an end product, the end product must be placed in a room or container having an elevated temperature (e.g., a “hot room”) to reduce the likelihood of dimensional changes in the article, for example at around 80 degrees Celsius or lower for about 4 to 8 hours. During this period of time at elevated temperature, the typical end product stabilizes and the pressure within individual cells equilibrizes such that dimensions of the typical end product do not change much, if at all, as compared to immediately after formation. Were the typical end product not be placed in the room or container having an elevated temperature for a period of time, the dimensions of the end product would change, potentially so much so that the end product would be out of tolerance.

However, it has been found that the encapsulation of the unactivated biomass-based carbonaceous particulate material in the thermoplastic foam increases the dimensional stability of the thermoplastic foam composition to such an extent that the end product formed from the thermoplastic foam composition need not be placed in a room or container at elevated temperature. While not intending to be bound by theory, it is believed that the unactivated biomass-based carbonaceous particulate material makes the heat distribution during and after forming the end product (e.g., during and after molding) more uniform. This uniformity in heat distribution also makes the relative pressures in each cell of the thermoplastic foam composition more uniform, and thus preserves the dimensions of the end product. Preservation of the dimensions of the end product is important to ensure that the end product is within the correct tolerances for the end product.

A method of manufacturing the thermoplastic polyurethane foam composition is also provided. The method may include the step of extruding a thermoplastic polyurethane material and the biomass-based carbonaceous particulate material encapsulated in the thermoplastic polyurethane material. The thermoplastic polyurethane material may be extruded directly as the thermoplastic polyurethane foam. Alternatively, the method may include the step of expanding the thermoplastic polyurethane material to form the thermoplastic polyurethane foam and the biomass-based carbonaceous particulate material encapsulated in the thermoplastic polyurethane foam.

The following examples are intended to illustrate the present disclosure and are not to be read in any way as limiting to the scope of the present disclosure.

### Examples 1-5

Examples 1-5 are of thermoplastic foam compositions that are in accordance with the subject disclosure and which can be found in Tables 1-3. Each of Examples 1-5 correspond to Trials 1-5 in Tables 1-3, respectively. The thermoplastic foam compositions used in Trials 1-5 of Tables 1-3 have the same composition, a thermoplastic foam composition including an expanded polypropylene and 5 percent by weight unactivated biomass-based carbonaceous particulate material, but which were produced under different processing parameters. Controls 1 and 2 of Tables 1-3 are not formed in accordance with the subject disclosure and are included to highlight advantages of the thermoplastic foam composition as described herein. More specifically, Controls 1 and 2 include a typical foam composition including an expanded polypropylene and 3 percent by weight of carbon black.

Referring now to Table 1, the thermoplastic foam compositions of Trials 1-5 were formed to have core densities ranging between 17.9 grams per liter and 56.4 grams per liter as measured pursuant to ASTM-D3575-W Test Method A. As can be seen in Table 1, each of Trials 1-5 measured elastic modulus pursuant to ASTM-C203 Method I, Equation 13, ranging from 406.4 pounds per square inch to 2009.3 pounds per square inch. Comparing Trials 1-5 to Controls 1 and 2 in Table 1, it is clear that the encapsulation of the unactivated biomass-based carbonaceous particulate material increases the elastic modulus of the thermoplastic foam composition. More specifically, comparing now Trial 4 and Control 1, although having both similar nominal densities and similar core densities, Trial 4 has a much higher elastic modulus. Trial 4 has an elastic modulus of 801.8, while Control 1 has only an elastic modulus of 670.1. It is thus clear that Trial 4 has an elastic modulus of almost 20% greater than that of the reference thermoplastic foam which omits the unactivated biomass-based carbonaceous particulate material (e.g., Control 1).

Referring still to Table 1, each of Trials 1-5 also measured compression set percentage pursuant to ASTM-3575-B at both 25% strain and 50% strain. The compression set percentages at 25% strain of Trials 1-5 ranged from 4 to 16 percent, and the compression set percentages at 50% of Trials 1-5 ranged from 22-27 percent. Comparing Trials 1-5 to Controls 1 and 2 in Table 1, it is clear that the compression set percentage at both 25% strain and 50% strain does not decrease much, if at all, with the encapsulation of the unactivated biomass-based carbonaceous particulate material. More specifically, comparing now Trial 4 and Control 1, both similar nominal densities, similar core densities, similar compression set percentage at 25% strain, and similar compression set percentage at 50% strain can be seen. It is thus clear that Trial 4 has a compression set percentage at 25% strain which is within 25% as that of the reference thermoplastic foam which omits the unactivated biomass-based carbonaceous particulate material (e.g., Control 1). It is also clear that Trial 4 has a compression set percentage at 50% strain which is within 25% as that of the reference thermoplastic foam which omits the unactivated biomass-based carbonaceous particulate material (e.g., Control 1).

Referring now to Table 2, each of Trials 1-5 further measured flexural strength pursuant to ASTM-C203. The flexural strengths of Trials 1-5 ranged from 10.4 pounds per square inch to 53.1 pounds per square inch. Comparing Trials 1-5 to Controls 1 and 2 in Table 2, it is clear that the flexural strengths do not decrease much, if at all, with the encapsulation of the unactivated biomass-based carbonaceous particulate material. More specifically, comparing now Trial 4 and Control 1, both similar nominal densities, similar core densities, and similar flexural strengths can be seen. It is thus clear that Trial 4 has a flexural strength which is within 10% as that of the reference thermoplastic foam which omits the unactivated biomass-based carbonaceous particulate material (e.g., Control 1). Similar conclusions can be drawn upon comparison on the compression strength at 10% strain, at 25% strain, at 50% strain, and at 75% strain.

Referring now to Table 3, each of Trials 1-5 further measured tensile strength and tensile elongation, both according to ASTM-3575-T. Similar conclusions can be drawn as to the effect of encapsulation of the unactivated biomass-based carbonaceous particulate material in relation to tensile strength and tensile elongation upon review of Table 3. As such, it is clear that encapsulation of the unactivated biomass-based carbonaceous particulate material does not negatively affect the physical properties of the thermoplastic foam composition.

Moreover, still referring to Table 3, the flammability horizontal burning rate as measured pursuant to Test Method FMVSS No. 302 showed that encapsulation of the unactivated biomass-based carbonaceous particulate material had significant improvement in the thermoplastic foam composition's flame-retardancy. More specifically, Trials 1-4 showed self-extinguishing characteristics. Trial 5 had a flammability horizontal burn rate of under 40 millimeters per minute. Compared to Control 1, which had a flammability horizontal burn rate of 74 millimeters per minute, and compared to Control 2, which had a flammability horizontal burn rate of 47 millimeters per minute, it is clear that all of Trials 1-5 showed a marked improvement in flame-retardation. Such a result was unexpected due to the underlying unactivated biomass-based carbonaceous particulate material—and the biomass (e.g., wood) from which it is derived-being susceptible to catching fire. Moreover, flame-retardation is particularly important in end products in automotive applications, such as seat structures.

TABLE 1

| | | | Measured | | | |
|---|---|---|---|---|---|---|
| | | | Core | Compression set | | Elastic |
| | | | Density | [%] | | Modulus |
| | | Nominal | [g/l] | ASTM-3575-B | | [psi] |
| | Thermoplastic Foam | Density | ASTM- | at 25% | at 50% | ASTM- |
| Trial | Composition | [g/l] | D3575-W | strain | strain | C203 |
| Trial 1 | Expanded Polypropylene + 5 | 20 | 17.9 | 8 | 25 | 406.4 |
| | wt % Unactivated Biomass- | | | | | |
| | Based Carbonaceous | | | | | |
| | Particulate Material | | | | | |
| Trial 2 | Expanded Polypropylene + 5 | 24 | 21 | 4 | 27 | 627.4 |
| | wt % Unactivated Biomass- | | | | | |
| | Based Carbonaceous | | | | | |
| | Particulate Material | | | | | |
| Trial 3 | Expanded Polypropylene + 5 | 25 | 21.3 | 8 | 24 | 412.8 |
| | wt % Unactivated Biomass- | | | | | |
| | Based Carbonaceous | | | | | |
| | Particulate Material | | | | | |
| Trial 4 | Expanded Polypropylene + 5 | 30 | 26.4 | 7 | 22 | 801.8 |
| | wt % Unactivated Biomass- | | | | | |
| | Based Carbonaceous | | | | | |
| | Particulate Material | | | | | |
| Trial 5 | Expanded Polypropylene + 5 | 60 | 56.4 | 16 | 20 | 2009.3 |
| | wt % Unactivated Biomass- | | | | | |
| | Based Carbonaceous | | | | | |
| | Particulate Material | | | | | |
| Control 1 | Expanded Polypropylene + 3 | 30 | 26 | 9 | 26 | 670.1 |
| | wt % Carbon Black | | | | | |
| Control 2 | Expanded Polypropylene + 3 | 45 | 45.4 | 7.5 | 23 | 1715.8 |
| | wt % Carbon Black | | | | | |

TABLE 2

| | | Flexural | Compressive Strength [kPa] | | | |
|---|---|---|---|---|---|---|
| | | Strength | ASTM-3575-D | | | |
| | Thermoplastic Foam | [psi] | at 10% | at 25% | at 50% | at 75% |
| Trial | Composition | ASTM-C203 | strain | strain | strain | strain |
| Trial 1 | Expanded Polypropylene + 5 | 10.4 | 45.5 | 72.7 | 132 | 325.4 |
| | wt % Unactivated Biomass- | | | | | |
| | Based Carbonaceous | | | | | |
| | Particulate Material | | | | | |
| Trial 2 | Expanded Polypropylene + 5 | 14.4 | 65 | 93 | 156 | 363 |
| | wt % Unactivated Biomass- | | | | | |
| | Based Carbonaceous | | | | | |
| | Particulate Material | | | | | |
| Trial 3 | Expanded Polypropylene + 5 | 11.2 | 43.5 | 77.2 | 145.2 | 353.7 |
| | wt % Unactivated Biomass- | | | | | |
| | Based Carbonaceous | | | | | |
| | Particulate Material | | | | | |
| Trial 4 | Expanded Polypropylene + 5 | 18.9 | 68.1 | 107.6 | 181.7 | 417.2 |
| | wt % Unactivated Biomass- | | | | | |
| | Based Carbonaceous | | | | | |
| | Particulate Material | | | | | |
| Trial 5 | Expanded Polypropylene + 5 | 53.1 | 235.5 | 307.2 | 422.7 | 872.7 |
| | wt % Unactivated Biomass- | | | | | |
| | Based Carbonaceous | | | | | |
| | Particulate Material | | | | | |
| Control 1 | Expanded Polypropylene + 3 | 18.8 | — | 128 | 195 | 405 |
| | wt % Carbon Black | | | | | |
| Control 2 | Expanded Polypropylene + 3 | 44.9 | — | 263 | 359 | 724 |
| | wt % Carbon Black | | | | | |

TABLE 3

| | | Tensile | Tensile | Flammability |
|---|---|---|---|---|
| | | Strength | Elongation | Horizontal Burning |
| | Thermoplastic Foam | [kPa] | [%] | rate[mm/min] |
| Trial | Composition | ASTM-3575-T | ASTM-3575-T | FMVSS 302 |
| Trial 1 | Expanded Polypropylene + 5 | 136.5 | 10.2 | 0 |
| | wt % Unactivated Biomass- | | | Self-extinguishing |
| | Based Carbonaceous | | | |
| | Particulate Material | | | |
| Trial 2 | Expanded Polypropylene + 5 | 234 | 12.3 | 0 |
| | wt % Unactivated Biomass- | | | Self-extinguishing |
| | Based Carbonaceous | | | |
| | Particulate Material | | | |
| Trial 3 | Expanded Polypropylene + 5 | 168.4 | 10.5 | 0 |
| | wt % Unactivated Biomass- | | | Self-extinguishing |
| | Based Carbonaceous | | | |
| | Particulate Material | | | |
| Trial 4 | Expanded Polypropylene + 5 | 237.5 | 10.3 | 0 |
| | wt % Unactivated Biomass- | | | Self-extinguishing |
| | Based Carbonaceous | | | |
| | Particulate Material | | | |
| Trial 5 | Expanded Polypropylene + 5 | 554.4 | 8.9 | Max 40 |
| | wt % Unactivated Biomass- | | | |
| | Based Carbonaceous | | | |
| | Particulate Material | | | |
| Control 1 | Expanded Polypropylene + 3 | 230 | 14.39 | 74 |
| | wt % Carbon Black | | | |
| Control 2 | Expanded Polypropylene + 3 | 460 | 11.78 | 47 |
| | wt % Carbon Black | | | |

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

1. A thermoplastic foam composition for low-density and high-stiffness articles, said thermoplastic foam composition comprising:
a thermoplastic foam; and
an unactivated biomass-based carbonaceous particulate material encapsulated in said thermoplastic foam;
wherein said thermoplastic foam composition has a core density of between 12 grams per liter and 400 grams per liter as measured pursuant to ASTM-D3575-W Test Method A, and
wherein said thermoplastic foam composition has an elastic modulus of between 60 pounds per square inch and 3500 pounds per square inch as measured pursuant to ASTM-C203 Method I, Equation 13.

2. The thermoplastic foam composition as set forth in claim 1, wherein said unactivated biomass-based carbonaceous particulate material has a specific surface area of between 150 square meters per gram of said unactivated biomass-based carbonaceous particulate material and 495 square meters per gram of said unactivated biomass-based carbonaceous particulate material.

3. (canceled)

4. The thermoplastic foam composition as set forth in claim 1, wherein said unactivated biomass-based carbonaceous particulate material is between 0.1 percent by weight and 25 percent by weight of said thermoplastic foam composition.

5. (canceled)

6. (canceled)

7. The thermoplastic foam composition as set forth in claim 1, wherein said unactivated biomass-based carbonaceous particulate material has a D50 particle size between 0.2 microns and 12.5 microns.

8. (canceled)

9. The thermoplastic foam composition as set forth in claim 1, wherein said unactivated biomass-based carbonaceous particulate material has a percentage of modern carbon (pMC) greater than 75% as measured pursuant to ASTM D6866.

10. (canceled)

11. The thermoplastic foam composition as set forth in claim 1, which is self-extinguishing and free of a flame-retardant other than said unactivated biomass-based carbonaceous particulate material.

12. The thermoplastic foam composition as set forth in claim 1, wherein said thermoplastic foam defines cells having a unimodal cell structure distribution and wherein said cells have an average size of less than 200 microns.

13. (canceled)

14. (canceled)

15. The thermoplastic foam composition as set forth in claim 1, wherein said elastic modulus is at least 10% greater than that of a reference thermoplastic foam having said thermoplastic foam of said thermoplastic foam composition but which omits said unactivated biomass-based carbonaceous particulate material, as measured pursuant to ASTM-C203 Method I, Equation 13.

16. The thermoplastic foam composition as set forth in claim 15, which has a compression set percentage at 25% strain which is within 25% as that of said reference thermoplastic foam which omits said unactivated biomass-based carbonaceous particulate material, as measured pursuant to ASTM-D3575-B.

17. The thermoplastic foam composition as set forth in claim 15, which has a flexural strength which is within 10% as that of said reference thermoplastic foam which omits said unactivated biomass-based carbonaceous particulate material, as measured pursuant to ASTM-C203.

18. The thermoplastic foam composition as set forth in claim 1, which has a compressive strength at 50% strain of at least 40 kilopascals as measured pursuant to ASTM-D3575-D.

19. The thermoplastic foam composition as set forth in claim 1, wherein said thermoplastic foam comprises expanded polypropylene, and wherein said expanded polypropylene comprises at least one chosen from 1) expanded ethylene propylene 1-butylene terpolymer and 2) at least 50 percent by weight of a copolymer of polypropylene and between 5 percent by weight and 30 percent by weight of ethylene propylene rubber.

20. (canceled)

21. (canceled)

22. (canceled)

23. The thermoplastic foam composition as set forth in claim 1, wherein said core density is between 12 grams per liter and 68 grams per liter as measured pursuant to ASTM-D3575-W Test Method A.

24. The thermoplastic foam composition as set forth in claim 1, wherein said thermoplastic foam comprises a thermoplastic elastomer obtained by polycondensation of a carboxylic acid polyamide with an alcohol terminated polyether.

25. The thermoplastic foam composition as set forth in claim 1, wherein said thermoplastic foam comprises thermoplastic polyurethane.

26. A thermoplastic polyurethane foam composition for low-density and high-stiffness articles, said thermoplastic polyurethane foam composition comprising:
a thermoplastic polyurethane foam; and
a biomass-based carbonaceous particulate material encapsulated in said thermoplastic polyurethane foam;
wherein said thermoplastic polyurethane foam composition has a core density of between 80 grams per liter and 400 grams per liter as measured pursuant to ASTM-D3575-W Test Method A, and
wherein said thermoplastic polyurethane foam composition has an elastic modulus of between 60 pounds per square inch and 700 pounds per square inch as measured pursuant to ASTM-C203 Method I, Equation 13.

27. The thermoplastic polyurethane foam composition as set forth in claim 26, wherein said biomass-based carbonaceous particulate material has a specific surface area of between 150 square meters per gram of said biomass-based carbonaceous particulate material and 2000 square meters per gram of said biomass-based carbonaceous particulate material.

28. The thermoplastic polyurethane foam composition as set forth in claim 27, wherein said biomass-based carbonaceous particulate material is further defined as an unactivated biomass-based carbonaceous particulate material, and wherein said unactivated biomass-based carbonaceous particulate material has a specific surface area of between 150 square meters per gram of said unactivated biomass-based carbonaceous particulate material and 495 square meters per gram of said unactivated biomass-based carbonaceous particulate material.

29. The thermoplastic polyurethane foam composition as set forth in claim 27, wherein said biomass-based carbonaceous particulate material is further defined as an activated biomass-based carbonaceous particulate material, and wherein said activated biomass-based carbonaceous particulate material has a specific surface area of between 495 square meters per gram of said activated biomass-based carbonaceous particulate material and 2000 square meters per gram of said activated biomass-based carbonaceous particulate material.

30. The thermoplastic polyurethane foam composition as set forth claim 26, wherein said biomass-based carbonaceous particulate material is between 0.1 percent by weight and 25 percent by weight of said thermoplastic polyurethane foam composition.

31. (canceled)

32. (canceled)

33. The thermoplastic polyurethane foam composition as set forth in claim 26, wherein said biomass-based carbonaceous particulate material has a D50 particle size between 0.1 micron and 200 microns.

34. (canceled)

35. The thermoplastic polyurethane foam composition as set forth in claim 26, wherein said biomass-based carbonaceous particulate material has a percentage of modern carbon (pMC) greater than 75% as measured pursuant to ASTM D6866.

36. (canceled)

37. The thermoplastic polyurethane foam composition as set forth in claim 26, which is self-extinguishing and free of a flame-retardant other than said biomass-based carbonaceous particulate material.

38. The thermoplastic polyurethane foam composition as set forth in claim 26, wherein said thermoplastic polyurethane foam defines cells having a unimodal cell structure distribution, and wherein said cells have an average size of less than 200 microns.

39. (canceled)

40. (canceled)

41. The thermoplastic polyurethane foam composition as set forth in claim 26, wherein said elastic modulus is at least 10% greater than that of a reference thermoplastic polyurethane foam having said thermoplastic polyurethane foam of said thermoplastic polyurethane foam composition but which omits said biomass-based carbonaceous particulate material, as measured pursuant to ASTM-C203 Method I, Equation 13.

42. The thermoplastic polyurethane foam composition as set forth in claim 41, which has a compression set percentage at 25% strain which is within 25% as that of said reference thermoplastic polyurethane foam which omits said biomass-based carbonaceous particulate material, as measured pursuant to ASTM-D3575-B.

43. The thermoplastic polyurethane foam composition as set forth in claim 41, which has a flexural strength which is within 10% as that of said reference thermoplastic polyurethane foam which omits said biomass-based carbonaceous particulate material, as measured pursuant to ASTM-C203.

44. The thermoplastic polyurethane foam composition as set forth in claim 26, which has a compressive strength at 50% strain of at least 40 kilopascals as measured by ASTM-D3575-D.

45. (canceled)

46. (canceled)
